(19) United States
(12) Patent Application Publication
(10) Pub. No.: US 2013/0249345 A1
(43) Pub. Date: Sep. 26, 2013

(54) SEGMENTED ROTOR IN A ROTOR ASSEMBLY

(71) Applicants: Edward L. Kaiser, Orion, MI (US); Peter Bostwick, Rochester, MI (US); Pankaj Mithal, Ann Arbor, MI (US)

(72) Inventors: Edward L. Kaiser, Orion, MI (US); Peter Bostwick, Rochester, MI (US); Pankaj Mithal, Ann Arbor, MI (US)

(73) Assignee: GM GLOBAL TECHNOLOGY OPERATIONS LLC, Detroit, MI (US)

(21) Appl. No.: 13/427,158

(22) Filed: Mar. 22, 2012

(51) Int. Cl. H02K 1/28

(52) U.S. Cl. 310/216.009

(57) ABSTRACT

A rotor assembly is provided. The assembly includes a hub and a rotor core having a first rotor lamination positioned at least partially around the hub. The first rotor lamination is at least partially defined by a first segment and a second segment that are configured to connect or interlock. The first segment includes a projection extending from a first body. The projection is configured to engage with a corresponding notch in the second segment in order to connect the first segment to the second segment. At least one first mounting tab extends from the first body and is configured to engage with a corresponding first groove on an outer periphery of the hub in order to connect the first segment to the hub.

### TECHNICAL FIELD

This disclosure relates to electric machines and, more specifically, to rotors for electric machines.

### BACKGROUND

An electric motor uses electric potential energy to produce mechanical energy through the interaction of magnetic fields and current-carrying conductors. The reverse process, using mechanical energy to produce electrical energy, is accomplished by a generator or dynamo. Other electric machines, such as motor/generators, combine various features of both motors and generators.

Electric machines may include an element rotatable about a central axis. The rotatable element, which may be referred to as a rotor, may be coaxial with a static element, which may be referred to as a stator. The electric machine uses relative rotation between the rotor and stator to produce mechanical energy or electrical energy.

### SUMMARY

A rotor assembly is provided. The rotor assembly includes a hub and a rotor core having a first rotor lamination positioned at least partially around the hub. The first rotor lamination is at least partially defined by a first segment and a second segment that are configured to connect or interlock. The first segment includes a projection extending from a first body. The projection is configured to engage with a corresponding notch in the second segment in order to connect the first segment to the second segment. At least one first mounting tab extends from the first body and is configured to engage with a corresponding first groove on an outer periphery of the hub in order to connect the first segment to the hub.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic, perspective view of a rotor assembly having a hub and rotor core formed from laminations having a plurality of segments per lamination, in accordance with a first embodiment;

FIG. 2 is a schematic, fragmentary, top view of the rotor core and hub shown in FIG. 1, with other components removed for clarity;

FIG. 3 is a schematic, fragmentary, close-up view of portion 3 shown in FIG. 2;

FIG. 4 is a schematic, fragmentary, top view of a rotor assembly having a rotor core and hub, in accordance with a second embodiment; and

FIG. 5 is a schematic, fragmentary, close-up view of portion 5 shown in FIG. 4.

### DETAILED DESCRIPTION

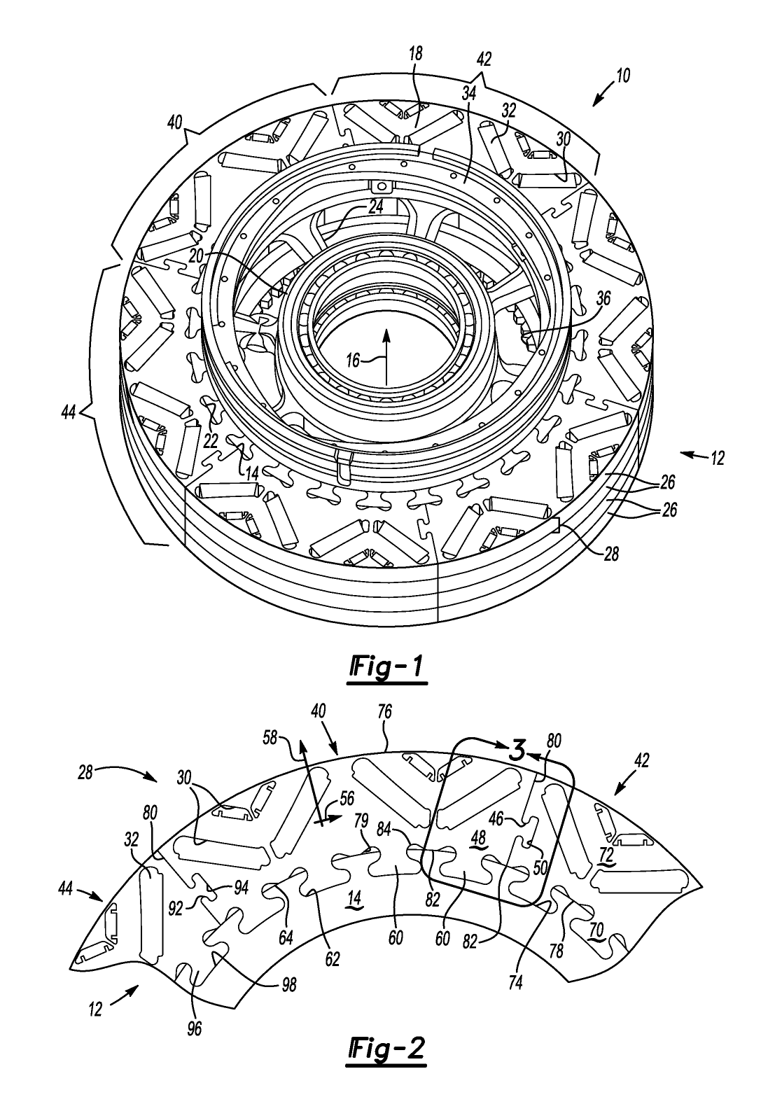

Referring to the Figures, wherein like reference numbers refer to the same or similar components throughout the several views, FIG. 1 is a schematic, perspective view of a rotor assembly 10 having a rotor core 12 and a hub 14, according to a first embodiment. The hub 14 is longitudinally disposed around a center axis 16. An end face 18 of the rotor core 12 is shown in FIG. 1. The hub 14 may include inner and outer portions 20, 22 that are concentric and connected via spokes 24. The hub 14 may be a single cylindrical shaft (not shown). The rotor core 12 is positioned at least partially around the hub 14. As illustrated in FIG. 1, the rotor core 12 is formed by stacking a plurality of rotor laminations 26, such as first rotor lamination 28. The rotor core 12 is configured to be rotatable within a generally annular stator (not shown). Referring to FIG. 1, the assembly 10 may also include a speed and position sensor target 34 and a spline 36 that engages with a component (not shown) for transmitting torque from the assembly 10. The assembly 10 may also include an end ring, which is not shown for illustrative purposes.

FIG. 2 is a schematic top view of a portion of the rotor core 12 and hub 14 shown in FIG. 1, with other components removed for clarity. Referring to FIGS. 1-2, a plurality of slots 30 may be formed near the outer periphery of the first rotor lamination 28. The slots 30 may be partially filled with permanent magnets 32 (shown in FIG. 1). The first rotor lamination 28 is formed from a plurality of segments. Referring to FIGS. 1-2, a first segment 40 and a second segment 42 are configured to interlock and at least partially define the first rotor lamination 28. A third segment 44 is configured to interlock with the first segment 40 to further define the first rotor lamination 28. Employing a first rotor lamination 28 composed of a plurality of segments eliminates the need for a large blank size that is typically required for producing un-segmented rotor laminations. The first, second and third segments 40, 42 and 44 may be formed with the same or similar geometry. Alternatively, the first, second and third segments 40, 42, 44 may be formed having different geometries, for example, different shapes and numbers of slots 30.

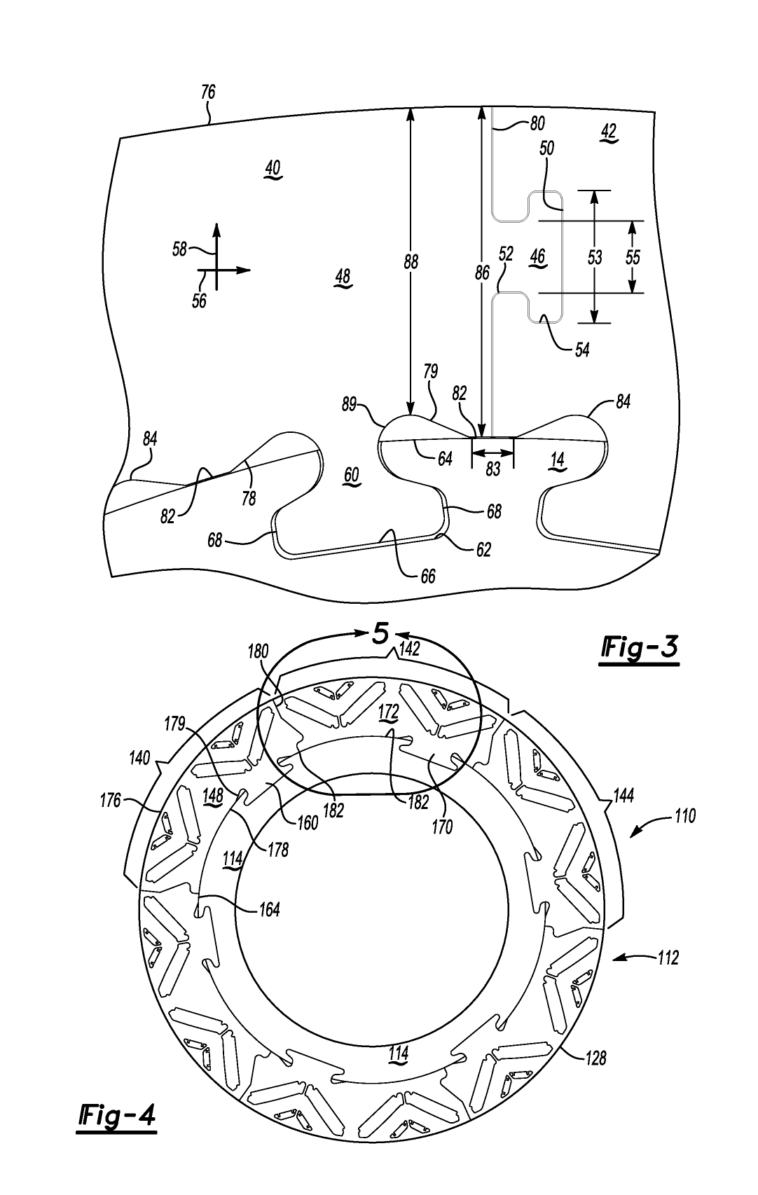

FIG. 3 is a schematic close-up view of portion 3 shown in FIG. 2, illustrating the interface between the first and second segments 40, 42 of the rotor core 12 (shown in FIG. 1). Referring to FIGS. 2-3, the first segment 40 includes a projection 46 extending from a first body 48. The projection 46 is configured to engage with a corresponding notch 50 in the second segment 42 in order to connect the first segment 40 to the second segment 42. The notch 50 is shaped to correspond to or conform to the projection 46 in order to provide a sufficiently snug fit.

The projection 46 may be shaped to provide sufficient hoop strength or stiffness to allow the rotor core 12 (and hub 14) to be rotated at higher speeds. Hoop strength and stiffness may be defined as the ability to resist circumferential forces. As the rotor core 12 spins, a component of force in the radial direction is induced due to centrifugal loading 58 (shown in FIGS. 2-3). The components of the rotor core 12 are pulled apart due to the centrifugal loading. Some of the radial loading is carried across the projection 46, thereby inducing a tangential load 56 (shown in FIGS. 2-3) into the rotor core 12. The first segment 40 is configured to share the structural or tangential load 56 of the second segment through the projection 46.

The projection 46 is configured to have a shape that provides locking capability, i.e. a shape that locks or holds the first and second segments 40, 42 together as the rotor core 12 and hub 14 spin. Referring to FIG. 3, in one example, the projection 46 may be defined by a proximal portion 52 and a distal portion 54, with the distal portion 54 having a width 53 that is greater than the width 55 of the proximal portion 52. The projection 46 may also be shaped in other ways that provide locking capability. The embodiment shown in FIGS. 1-3 may be used in applications where the rotor core 12 is moving at high speeds.

Referring to FIGS. 2-3, the first segment 40 may be connected to the hub 14 through one or more first mounting tabs 60 that extend from the first body 48. Referring to FIGS. 2-3, the first mounting tab 60 is configured to engage with a corresponding first groove 62 on an outer periphery 64 of the hub. The first groove 62 has an internal shape that corresponds to or conforms to the first mounting tab 60 in order to provide a sufficiently snug fit. As shown in FIGS. 2-3, the first mounting tab 60 may have a “dovetail” shape. Referring to FIG. 3, the first mounting tab 60 may be defined by an end 66 configured to be substantially parallel to the outer periphery 64 of the hub 14 and at least two tips 68 configured to be at least partially rounded and substantially perpendicular relative to the end 66.

Referring to FIG. 2, the second segment 42 includes one or more second mounting tabs 70 extending from a second body 72. Each second mounting tab 70 is configured to engage with a corresponding second groove 74 in the hub 14 in order to connect the second segment 42 to the hub 14, as shown in FIG. 2.

Referring to FIGS. 2-3, each of the segments 40, 42 (and segment 44 shown in FIGS. 1-2) may be defined by a respective outer profile 76, an inner profile 78 and edges 80. Referring to FIGS. 2-3, the inner profile 78 may be defined by at least one relief 79 that allows for a varying radius to be obtained at the inner profile 78. Stated differently, the inner profile 78 may be defined by at least abutting portion 82 (which abuts the outer periphery 64 of the hub 14) and at least one non-abutting portion 84 (which is spaced from the outer periphery 64 of the hub 14). The abutting portion 82 has a larger first radius 86 than the second radius 88 of the non-abutting portion 84. Referring to FIG. 3, the inner profile 78 may be formed with a rounded corner 89 between the relief 79 and the normal edge of the first mounting tab 60 (or second mounting tab 70), in order to reduce stress on the rotor core 12. Referring to FIG. 3, the abutting portion 82 may be defined by a width 83. By way of example only, the width 83 may be 1 mm.

Referring to FIGS. 1-2, a third segment 44 is configured to interlock with the first segment 40 to further define the first rotor lamination 28. In the embodiment shown, the first rotor lamination 12 is formed from six segments. However, any numbers of segments may be used to create each of the laminations or layers of the rotor core 12. Referring to FIG. 2, the third segment 44 includes a third projection 92 configured to engage with a corresponding notch 94 in the first segment 40, thereby connecting the first segment 40 to the third segment 44. Referring to FIG. 2, the third segment 44 includes a third mounting tab 96 configured to engage with a corresponding third groove 98 in the hub 14, in order to connect the third segment 44 to the hub 14.

FIG. 4 is a fragmentary schematic top view of a rotor assembly 110 according to a second embodiment. Referring to FIG. 4, the assembly 110 includes a hub 114 and a rotor core 112 having a first rotor lamination 128. The assembly 110 shown in FIG. 4 is similar to the assembly 10 in the first embodiment unless otherwise described.

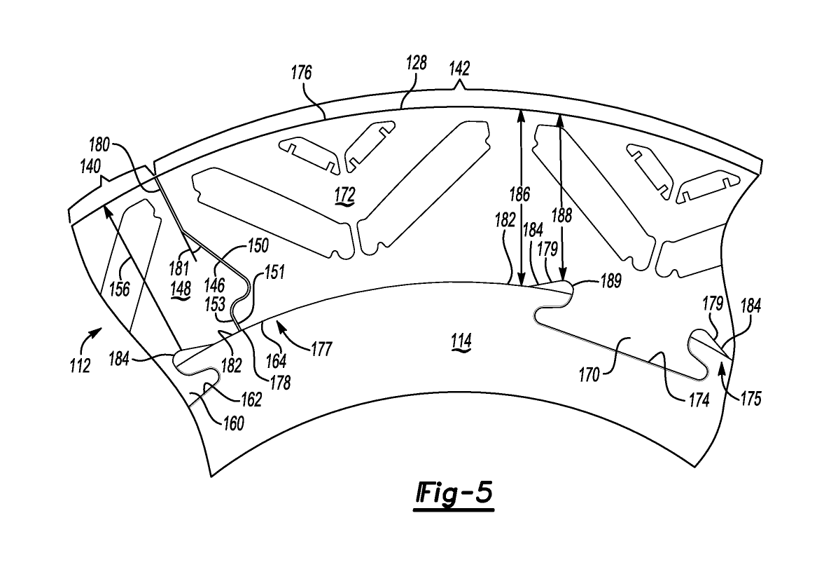

The first rotor lamination 128 is formed from a plurality of segments. Referring to FIG. 4, first, second and third segments 140, 142, 144 are configured to interlock and at least partially define the first rotor lamination 128. FIG. 5 is a schematic, fragmentary, close-up view of portion 5 shown in FIG. 4, showing the interface between segments 140, 142 and the hub 114. Referring to FIG. 5, the first segment 140 includes a projection 146 extending from a first body 148. The projection 146 is configured to engage with a corresponding notch 150 in the second segment 142 in order to connect the first segment 140 to the second segment 142. Referring to FIG. 5, the second segment 142 includes a protrusion 151 extending from a second body 172 and configured to engage with a corresponding recess 153 in the first segment 140.

Referring to FIG. 5, the interlocking of the projection 146 in the first segment 140 with the notch 150 in the second segment 142, and the protrusion 151 in the second segment 142 with the recess 153 in the first segment 140, keeps the first and second segments 140, 142 from twisting outwards or deflecting when the rotor core 112 (and hub 114) is spinning, that is, the interlocking supports the radial loads induced during spinning As the rotor core 112 spins, a component of force in the radial direction is induced due to centrifugal loading 156 (shown in FIG. 5). The components of the rotor core 112 are pulled apart due to the centrifugal loading 156. Referring to FIG. 5, some of the radial loading is carried across the projection 146. The embodiment shown in FIGS. 4-5 may be used in applications where the rotor core 112 is moving at low speeds. The number of mounting tabs 60, 70, 160, 170 in either embodiment may be varied depending on the particular application. For example, the number of mounting tabs 60, 70, 160, 170 may be selected based on the stress of the component, i.e., keeping the stress below the yield strength of the material used to form the hub 14 or 114 and first rotor lamination 28 or 128.

Similar to the first embodiment and referring to FIG. 5, the first and second segments 140, 142 are connected to the hub 114 through respective first and second mounting tabs 160, 170 inserted into respective grooves 162, 174 in the hub 114. The second mounting tab 170 attaching the second segment 142 to the hub 114 is positioned sufficiently close to the projection 146 so that the forces acting on the first segment 140 will be transmitted to second segment 142 and then directly into the hub 114. This minimizes deflection of the first rotor lamination 128.

Referring to FIGS. 4-5, each of the segments 140, 142, 144 may be defined by a respective outer profile 176, an inner profile 178 and edges 180. Referring to FIG. 5, the projection 146 of the first segment 140 is configured to be inclined relative to the edge 180, as shown by the angle of incline 181. In one example, the angle of incline 181 is 30 degrees.

Referring to FIG. 5, the inner profile 178 may be defined by at least one relief 179 that allows for a varying radius to be obtained at the inner profile 178. Stated differently, the inner profile 178 may be defined by at least abutting portion 182 (which abuts the outer periphery 164 of the hub 114) and at least one non-abutting portion 184 (which is spaced from the outer periphery 164 of the hub 114). The abutting portion 182 has a larger first radius 186 than the second radius 188 of the non-abutting portion 184. Referring to FIG. 5, the inner profile 178 may be formed with a rounded corner 189 between the relief 179 and the normal edge of the second mounting tab 170 (or first mounting tab 160), in order to reduce stress on the rotor core 112.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A rotor assembly comprising:
a hub;
a rotor core having a first rotor lamination positioned at least partially around the hub;
a first segment and a second segment configured to connect and at least partially define the first rotor lamination;
wherein the first segment includes:
a first body; and
a projection extending from the first body and configured to engage with a corresponding notch in the second segment in order to connect the first segment to the second segment.

2. The assembly of claim 1, further comprising:
at least one first mounting tab extending from the first body and configured to engage with a corresponding first groove on an outer periphery of the hub, thereby connecting the first segment to the hub.

3. The assembly of claim 2, wherein the first mounting tab is defined by an end configured to be substantially parallel to the outer periphery of the hub and at least two tips configured to be at least partially rounded relative to the end.

4. The assembly of claim 1, wherein the first segment is defined by an outer profile and an inner profile; and
wherein a portion of the inner profile of the first segment is configured to abut the outer periphery of the hub and a portion of the inner profile of the first segment is configured to be spaced from the outer periphery of the hub.

5. The assembly of claim 1, wherein the projection is defined by a proximal portion and a distal portion such that the distal portion is wider than the proximal portion, thereby locking the first segment to the second segment when the projection is engaged with the notch.

6. The assembly of claim 1, wherein the second segment includes a protrusion configured to engage with a corresponding recess in the first segment.

7. The assembly of claim 1, wherein the first segment is defined by an outer profile, an inner profile and edges, and wherein the projection in the first segment is configured to be inclined relative to the edges.

8. The assembly of claim 1, wherein the second segment includes at least one second mounting tab configured to engage with a corresponding second groove in the hub in order to connect the second segment to the hub.

9. The assembly of claim 1, further comprising:
a third segment configured to interlock with the first segment to further define the first rotor lamination;
wherein the third segment includes:
a third projection configured to engage with a corresponding notch in the first segment in order to connect the third segment to the first segment; and
at least one third mounting tab configured to engage with a corresponding third groove in the hub in order to connect the third segment to the hub.

10. A rotor assembly comprising:
a hub;
a rotor formed from a plurality of laminations;
wherein each of the laminations is formed from a first segment and a second segment;
wherein the first segment includes:
a first body;
at least one first mounting tab extending from the first body and configured to engage with a corresponding first groove on an outer periphery of the hub in order to connect the first segment to the hub; and
at least one projection extending from the first body and configured to engage with a corresponding notch in the second segment in order to connect the first segment to the second segment;
wherein the first segment is defined by an outer profile, an inner profile and edges, the projection in the first segment being substantially inclined relative to the edges; and
wherein the second segment includes a protrusion configured to engage with a corresponding recess in the first segment.

11. The assembly of claim 10, wherein the first mounting tab is defined by an end configured to be substantially parallel to the outer periphery of the hub and at least two tips configured to be at least partially rounded relative to the end.

12. A rotor assembly comprising:
a hub;
a rotor formed from a plurality of laminations;
wherein each of the laminations is formed from a first segment and a second segment;
wherein the first segment includes:
a first body;
at least one first mounting tab extending from the first body and configured to engage with a corresponding first groove on an outer periphery of the hub in order to connect the first segment to the hub; and
at least one projection extending from the first body and configured to engage with a corresponding notch in the second segment in order to connect the first segment to the second segment;
wherein the projection is defined by a proximal portion and a distal portion such that the distal portion is wider than the proximal portion;
wherein a portion of an inner profile of the first segment is configured to abut the outer periphery of the hub and a portion of the inner profile of the first segment is configured to be spaced from the outer periphery of the hub.

13. The assembly of claim 12, wherein the first mounting tab is defined by an end configured to be substantially parallel to the outer periphery of the hub and at least two tips configured to be at least partially rounded relative to the end.
